(19) United States
(12) Patent Application Publication
(10) Pub. No.: US 2025/0374910 A1
(43) Pub. Date: Dec. 11, 2025

(54) MOBILE REMOVAL DEVICE

(71) Applicant: FUTABA INDUSTRIAL CO., LTD., Okazaki-shi (JP)

(72) Inventor: Masanori Okada, Okazaki-shi (JP)

(21) Appl. No.: 19/210,055

(22) Filed: May 16, 2025

(30) Foreign Application Priority Data
Jun. 10, 2024 (JP) 2024-093759

(51) Int. Cl. A01M 21/04

(52) U.S. Cl. CPC A01M 21/04

(57) ABSTRACT

Provided is a mobile removal device configured to irradiate, with a laser beam, a hindrance capable of inhibiting plant growth. The mobile removal device includes a camera, a laser oscillator, a controller, and a guide portion. The laser oscillator is configured to output a laser beam. The controller is configured to detect the hindrance on the ground based on a captured image taken by the camera and to irradiate the hindrance with the laser beam. The guide portion is configured to guide the laser beam output by the laser oscillator. The guide portion also includes a half mirror. The camera is configured to capture the ground through the half mirror.

### CROSS-REFERENCE TO RELATED APPLICATIONS

This application claims the benefit of priority based on Japanese Patent Application No. 2024-093759 filed on Jun. 10, 2024, with the Japan Patent Office, and the entire disclosure of which is incorporated herein by reference.

### BACKGROUND

The present disclosure relates to a mobile removal device configured to remove a hindrance that may inhibit plant growth.

As described in Japanese Unexamined Patent Application Publication No. 2023-116312, a mobile weeder is known which is configured to remove an undesirable plant occurring in agricultural land by irradiating the undesirable plant with a laser beam. The mobile weeder of Japanese Unexamined Patent Application Publication No. 2023-116312 includes a camera for capturing the ground below the device. The mobile weeder grasps a position of the undesirable plant based on a captured image taken by the camera, and emits a laser beam toward the undesirable plant from a laser irradiation device installed at a lower part of a body of the mobile weeder.

### SUMMARY

However, in the mobile weeder of Japanese Unexamined Patent Application Publication No. 2023-116312, a position of the laser irradiation device installed at the lower part of the body of the mobile weeding device is distanced from a position of the camera. Therefore, when an irradiation position of the laser beam is controlled, a correction process may be required with respect to a position determined based on the captured image taken by the camera, and/or an accuracy of the irradiation position may be reduced.

In one aspect of the present disclosure, it is desirable to optimally control the irradiation position of the laser beam.

One aspect of the present disclosure is a mobile removal device configured to irradiate, with a laser beam, a hindrance capable of inhibiting plant growth. The mobile removal device includes a camera, a laser oscillator, a controller, and a guide portion. The camera is configured to capture a ground. The laser oscillator is configured to output the laser beam. The controller is configured to detect the hindrance on the ground based on a captured image taken by the camera and to irradiate the hindrance with the laser beam. The guide portion is configured to guide the laser beam output by the laser oscillator. The guide portion includes a half mirror. The camera is configured to capture the ground through the half mirror.

With the above configuration, the hindrance can be optimally detected based on the captured image of the ground taken by the camera through the half mirror. In addition, a reflection position of the laser beam on the half mirror can be arranged in or close to an imaging range of the camera, which reduces the processing required to control the irradiation position of the laser beam. Therefore, the irradiation position of the laser beam can be optimally controlled.

One aspect of the present disclosure may further include an illuminator configured to illuminate the imaging range of the camera.

With the above configuration, the hindrance can be optimally detected based on the captured image.

In one aspect of the present disclosure, the half mirror may be configured to finally reflect the laser beam output by the laser oscillator. The camera may be provided with a wide-angle lens.

With the above configuration, the camera can capture the ground over a larger area.

In one aspect of the present disclosure, a reflection position of the laser beam on the half mirror may be on or close to an optical axis of the camera.

The above configuration reduces the processing required to control the irradiation position of the laser beam.

In one aspect of the present disclosure, the half mirror may be located below the camera.

With the above configuration, the camera can optimally capture the ground.

In one aspect of the present disclosure, the half mirror may be configured to reflect the laser beam to the ground located below, the laser beam being laterally incident.

With the above configuration, it is possible to optimally irradiate the hindrance on the ground with the laser beam.

In one aspect of the present disclosure, the laser beam may be visible light.

With the above configuration, the irradiation position of the laser beam can be optimally controlled.

In one aspect of the present disclosure, the hindrance may be an undesirable plant.

With the above configuration, the plant growth can be suitably promoted.

### BRIEF DESCRIPTION OF THE DRAWINGS

An embodiment of the present disclosure will be described hereinafter by way of example with reference to the accompanying drawings, in which:

FIG. 1A is an explanatory diagram showing a mobile removal device as seen from the front;

FIG. 1B is an explanatory diagram showing the mobile removal device and an image recognition region; and

FIG. 2 is an explanatory diagram showing a path taken by the mobile removal device at the time of performing a weeding operation.

### DETAILED DESCRIPTION OF EXEMPLARY EMBODIMENTS

Hereinafter, an example embodiment of the present disclosure will be described with reference to the drawings.

### 1. Overview

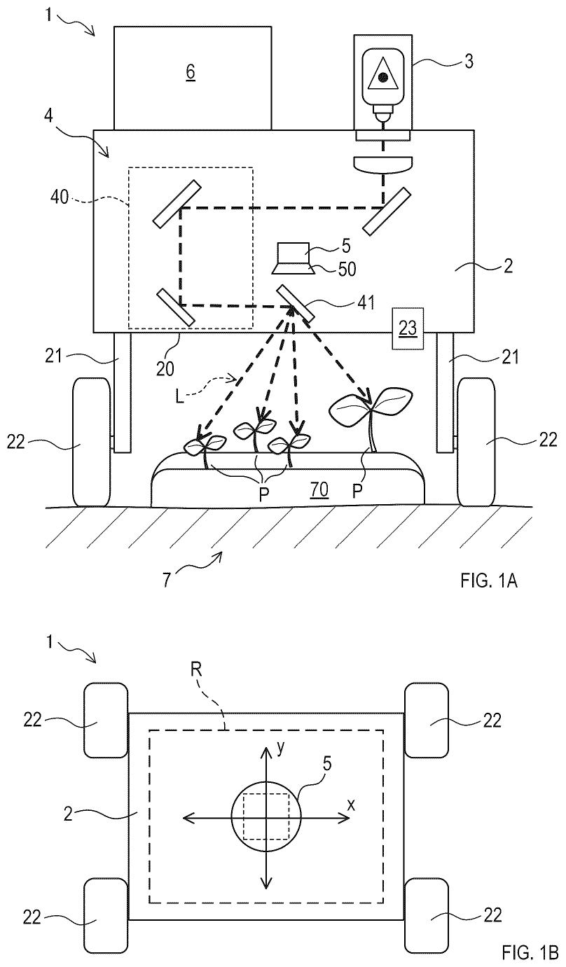

A mobile removal device 1 is configured to irradiate, with a laser beam L, an undesirable plant P (e.g., a weed) that has grown around a crop 71 in an agricultural land 7 and that may inhibit the growth of the crop 71 to thereby remove the undesirable plant P (see. FIG. 1A). The mobile removal device 1 is movable, and detects the undesirable plant P while moving through the agricultural land and irradiates the detected undesirable plant P with the laser beam L. The mobile removal device 1 includes a main body 2, a laser oscillator 3, a guide portion 4, a camera 5 and a controller 6.

### 2. Main Body

The main body 2 is a housing that holds the laser oscillator 3, the guide portion 4, the camera 5, the controller 6, and a battery or the like that is not shown (see FIG. 1A). The main body 2 is also provided with a plurality of legs 21, a plurality of wheels 22, and an illuminator 23.

The legs 21 are provided around the edge of a lower part 20 of the main body 2, which is a part facing the ground, and protrude downward. The legs 21 are respectively provided with the wheels 22 for moving the mobile removal device 1 at the lower ends of the legs. As an example, these wheels 22 may be driven by a motor that is not shown. Of course, the mobile removal device 1 is not limited to the foregoing, and may be configured to be moved by an operator pushing or pulling the main body 2. The main body 2 may be provided with one or more electric crawlers, for example, instead of the wheels 22.

The illuminator 23 is provided in a lower part 20 of the main body 2 and illuminates an area of the ground below the main body 2.

### 3. Camera

The camera 5 is provided in the lower part 20 of the main body 2 and includes a wide-angle lens 50 (see FIG. 1A). The camera 5 is configured to capture an area of the ground facing the lower part 20, i.e., an area directly below the main body 2, using the wide-angle lens 50 (see FIG. 1B). Of course, the camera 5 is not limited to this configuration, and may also capture the vicinity of the area directly below the main body 2.

As will be described in more detail below, the mobile removal device 1 detects the undesirable plant P within an image recognition region R included in an imaging range of the camera 5 on the ground and irradiates the undesirable plant P with the laser beam L.

### 4. Laser Oscillator

The laser oscillator 3 is configured to output the laser beam L (see FIG. 1A). As an example, a semiconductor laser may be used as the laser oscillator 3; however, other oscillators that output the laser beam L in various ways may be used without being limited to this configuration.

The laser beam L is visible light, for example. More specifically, the laser beam L has a wavelength of 400 nm or more and 550 nm or less, for example, and a blue laser is used as the laser beam L. The blue laser is in a wavelength range where energy is not easily absorbed by water. Thus, the blue laser can efficiently remove a plant even if the plant is covered with water components, such as rain. Of course, the laser beam L is not limited to the foregoing. For example, a laser beam L other than the blue laser and a laser beam L other than the visible light may be used.

### 5. Guide Portion

The guide portion 4 includes a plurality of optical elements and is configured to guide the laser beam L output by the laser oscillator 3 so that the laser beam L is emitted from the lower part 20 of the main body 2 downward to the undesirable plant P located below the main body 2 (see FIG. 1A). Specifically, the guide portion 4 includes two galvanometer mirrors 40 and a half mirror 41.

The two galvanometer mirrors 40 are arranged side by side and the laser beam L output by the laser oscillator 3 is sequentially reflected by the galvanometer mirrors 40. As an example, the galvanometer mirror 40, which reflects the laser beam L last, is located laterally with respect to the half mirror 41.

The two galvanometer mirrors 40 correspond to an x-axis direction and a y-axis direction, respectively. As an example, the y-axis may extend parallel to a direction of travel of the mobile removal device 1 and the x-axis may extend in a direction perpendicular to the direction of travel. Each galvanometer mirror 40 changes its orientation by a galvanometer scanner in accordance with a signal from the controller 6 to thereby change the path of the laser beam L. This displaces an irradiation position of the laser beam L in the corresponding direction. Of course, the number of galvanometer mirrors can be determined as appropriate, and for example, three galvanometer mirrors may be provided.

### 6. Half Mirror

The half mirror 41 is configured to receive the laser beam L that has been reflected by the galvanometer mirror 40 located laterally with respect to the half mirror 41 and to reflect the incident laser beam L toward the area of the ground below the main body 2 (see FIG. 1A). That is, the laser beam L output by the laser oscillator 3 is finally reflected by the half mirror 41 before the laser beam L is emitted from the lower part 20 of the main body 2 toward the ground.

As shown in FIG. 1A, the half mirror 41 is arranged below the camera 5 and its position is fixed. The half mirror 41 is positioned between the camera 5 and the ground, and the position of the half mirror 41 is within the imaging range below the camera 5. However, since a light that has passed through the half mirror 41 enters the camera 5, the camera 5 captures the ground through the half mirror 41. That is, even if the half mirror 41 overlaps with the ground, the camera 5 can capture a part of the ground that overlaps with the half mirror 41.

Note that the half mirror 41 may be located at a position corresponding to the image recognition region R (details will be described below) in the captured image taken by the camera 5. As an example, a reflection position 41A of the laser beam L on the half mirror 41 is on or close to an optical axis 50A of the wide-angle lens 50 of the camera 5. Of course, the reflection position 41A is not limited to the foregoing, and may be located at a position corresponding to anywhere within the image recognition region R in the captured image taken by the camera 5.

### 7. Controller

The controller 6 is a part that comprehensively controls the mobile removal device 1 and includes a CPU and a memory (see FIG. 1A). The CPU executes a program stored in the memory to thereby perform various functions of the mobile removal device 1. Note that the various functions performed by the controller 6 are not achieved solely by the execution of the program. Some or all of the functions may be achieved by one or more hardware components.

In addition, the controller 6 is configured to detect a location (hereinafter, referred to as “current location”) of the mobile removal device 1. Specifically, the controller 6 may detect the current location using, for example, GPS. Alternatively, the controller 6 may detect a speed and a direction of travel of the mobile removal device 1 using a sensor to thereby detect the current location based on these detection results.

### 8. Weeding Operation

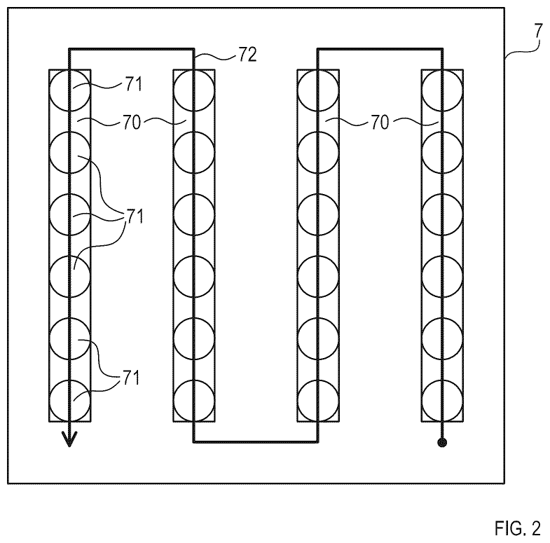

The mobile removal device 1 moves on the agricultural land 7 according to path information stored in the memory of the controller 6 and performs a weeding operation. As shown in FIG. 2, the path information indicates a path 72 along which the mobile removal device 1 moves on the agricultural land 7 and a stop position which is on the path 72 and at which the mobile removal device 1 stops to perform the weeding operation.

As an example, in each ridge 70 of the agricultural land 7, the crops 71 are cultivated at constant intervals (e.g., 60 cm). In the path information in FIG. 2, the path 72 is set along each ridge 70 as an example, and the mobile removal device 1 moves along the path 72 with the ridge 70 located between the wheels 22.

In the path information, the position of each crop 71 is set as the stop position. When the mobile removal device 1 stops at the stop position, the crop 71 at the stop position is located in the image recognition region R of the mobile removal device 1 (see FIG. 1B). The mobile removal device 1 moves along the path 72, stops at each stop position, and weeds around the crop 71.

Specifically, when the mobile removal device 1 stops at the stop position, the controller 6 causes the camera 5 to capture the area of the ground below the main body 2 through the half-mirror 41, and image data is generated. At this time, the controller 6 causes the illuminator 23 to illuminate the imaging range of the camera 5. However, the configuration is not limited to the foregoing, and the camera 5 may capture the ground without the imaging range of the camera 5 being illuminated.

The image recognition region R is a part excluding the peripheral area of the image of the ground shown by the image data. Of course, a region to be used as the image recognition region R in the image of the ground shown by the image data is not limited to the foregoing and may be determined as appropriate. The controller 6 performs image recognition of the image recognition region R based on the image data, detects the undesirable plant P in the image recognition region R, and determines XY coordinates at a specified position of the detected undesirable plant P as a target position of the laser beam L.

The controller 6 then sets an irradiation position of the laser beam L based on the determined target position. Specifically, the controller 6 may directly use the XY coordinates of the target position as the irradiation position, or may perform a correction process on the XY coordinates of the target position to thereby obtain XY coordinates and use them as the irradiation position. The controller 6 then controls the galvanometer mirrors 40 to thereby adjust an irradiation direction of the laser beam L, and emits the laser beam L toward the irradiation position. This causes the undesirable plant P to wither and die.

### 9. Effects

(1) According to the embodiment described above, the half-mirror 41 is arranged within the imaging range of the camera 5; however, the camera 5 can capture the ground through the half-mirror 41. Thus, the detection of the undesirable plant P based on the captured image taken by the camera 5 can be performed without interference. Therefore, it is possible to optimally detect the undesirable plant P based on the captured image.

The reflection position 41A of the laser beam L on the half mirror 41 can be arranged in or close to the imaging range of the camera 5. Thus, an origin of the XY coordinates for detecting the position of the undesirable plant P in the image recognition region R of the captured image can be coincident with or close to an origin of the XY coordinates for determining the irradiation position of the laser beam L. As a result, the XY coordinates of the specified position (i.e., the target position) of the undesirable plant P can be directly used as the XY coordinates of the irradiation position of the laser beam L. Alternatively, it is also possible to perform a simple correction process on the target position and then use the resultant XY coordinates as the XY coordinates of the irradiation position of the laser beam L. Accordingly, the processing required to control the irradiation position of the laser beam L can be reduced.

Therefore, it is possible to optimally control the irradiation position of the laser beam L.
(2) When the camera 5 captures the ground, the imaging range of the camera 5 is illuminated by the illuminator 23. This allows the camera 5 to capture the ground well through the half mirror 41, making it possible to optimally detect the plant based on the captured image taken by the camera 5.
(3) The camera 5 captures the ground with the wide-angle lens 50. This allows a single camera 5 to capture the ground over a larger area. As a result, it is possible to reduce the number of cameras 5 and simplify the configuration of the mobile removal device 1.
(4) As an example, the reflection position 41A of the laser beam L on the half mirror 41 is on or close to the optical axis 50A of the wide-angle lens 50 of the camera 5. As a result, the origin of the XY coordinates for detecting the position of the undesirable plant P based on the captured image can be coincident with or close to the origin of the XY coordinates for determining the irradiation position of the laser beam L. This reduces the processing required to control the irradiation position of the laser beam L.
(5) The laser beam L is visible light. Thus, it is possible to optimally control the irradiation position of the laser beam L.

### 10. Other Embodiments

(1) In the embodiment described above, the mobile removal device 1 is configured to irradiate the undesirable plant P with the laser beam L to thereby remove the undesirable plant P. However, the mobile removal device 1 is not limited to the foregoing and may be configured to remove hindrances other than plants by irradiating the hindrances with the laser beam L. Note that the hindrances are objects that may inhibit the growth of the crop 71, and as an example, pests can be the hindrances.
(2) In the embodiment described above, the mobile removal device 1 is configured to move on the ground. However, the mobile removal device 1 may be configured as a drone, for example, and may be configured to remove the hindrances such as the undesirable plant P while flying over the agricultural land 7 along a path similar to that of the embodiment described above.
(3) In the embodiment described above, the camera 5 is provided with the wide-angle lens 50. However, the camera 5 may be provided with a normal lens that is not the wide-angle lens 50. In this case, the laser beam L may be finally reflected by a reflector provided separately from the half mirror 41, instead of being finally reflected by the half mirror 41 before the laser beam L is emitted from the lower part 20 of the main body 2. In other words, the guide portion 4 may include a reflector which is different from the half mirror 41 and on which the laser beam L is finally reflected before being emitted.
(4) In the mobile removal device 1 of the embodiment described above, the main body 2 may further include a wall (not shown). The wall is a wall-shaped portion protruding from the edge of the lower part 20 of the main body 2 and surrounding the area on the ground below the main body 2. The camera 5 may be configured to capture the area on the ground surrounded by the wall.
(5) In the embodiment described above, the mobile removal device 1 is configured to perform the weeding operation in a state of being stopped at the stop position provided on the path 72 of the agricultural land 7. However, the mobile removal device 1 is not limited to this configuration, and may be configured to perform the weeding operation in a similar manner while moving along the path 72 without stopping at the stop position.
(6) Two or more functions of one element of the aforementioned embodiments may be achieved by two or more elements, and one function of one element may be achieved by two or more elements. Furthermore, two or more functions of two or more elements may be achieved by one element, and one function achieved by two or more elements may be achieved by one element. A part of the configurations of the aforementioned embodiments may be omitted. Furthermore, at least part of the configurations of the aforementioned embodiments may be added to or replaced with another configuration of the aforementioned embodiments.

### 11. Technical Ideas Disclosed Herein

### Item 1

A mobile removal device configured to irradiate, with a laser beam, a hindrance capable of inhibiting plant growth, the mobile removal device comprising:
a camera configured to capture a ground;
a laser oscillator configured to output the laser beam;
a controller configured to detect the hindrance on the ground based on a captured image taken by the camera and to irradiate the hindrance with the laser beam; and
a guide portion configured to guide the laser beam output by the laser oscillator,
the guide portion including a half mirror, and
the camera being configured to capture the ground through the half mirror.

### Item 2

The mobile removal device according to Item 1, further including an illuminator configured to illuminate an imaging range of the camera.

### Item 3

The mobile removal device according to Item 1 or 2,
wherein the half mirror is configured to finally reflect the laser beam output by the laser oscillator, and
wherein the camera is provided with a wide-angle lens.

### Item 4

The mobile removal device according to any one of Items 1 to 3,
wherein a reflection position of the laser beam on the half mirror is on or close to an optical axis of the camera.

### Item 5

The mobile removal device according to any one of Items 1 to 4,
wherein the laser beam is visible light.

What is claimed is:

1. A mobile removal device configured to irradiate, with a laser beam, a hindrance capable of inhibiting plant growth, the mobile removal device comprising:
a camera configured to capture a ground;
a laser oscillator configured to output the laser beam;
a controller configured to detect the hindrance on the ground based on a captured image taken by the camera and to irradiate the hindrance with the laser beam; and
a guide portion configured to guide the laser beam output by the laser oscillator,
the guide portion including a half mirror, and
the camera being configured to capture the ground through the half mirror.

2. The mobile removal device according to claim 1, further comprising an illuminator configured to illuminate an imaging range of the camera.

3. The mobile removal device according to claim 1,
wherein the half mirror is configured to finally reflect the laser beam output by the laser oscillator, and
wherein the camera is provided with a wide-angle lens.

4. The mobile removal device according to claim 1,
wherein a reflection position of the laser beam on the half mirror is on or close to an optical axis of the camera.

5. The mobile removal device according to claim 3,
wherein the half mirror is located below the camera.

6. The mobile removal device according to claim 5,
wherein the half mirror is configured to reflect the laser beam to the ground located below, the laser beam being laterally incident.

7. The mobile removal device according to claim 1,
wherein the laser beam is visible light.

8. The mobile removal device according to claim 1,
wherein the hindrance is an undesirable plant.
